(19) United States
(12) Patent Application Publication
(10) Pub. No.: US 2011/0109443 A1
(43) Pub. Date: May 12, 2011

(54) WIRELESS IC TAG, MANAGEMENT SYSTEM USING SAME

(76) Inventors: Kikuo Kaga, Tokyo (JP); Shigeo Ashizawa, Tokyo (JP)

(21) Appl. No.: 13/001,698

(22) PCT Filed: Oct. 6, 2009
(86) PCT No.: PCT/JP2009/067681

§ 371 Date: Dec. 28, 2010

(30) Foreign Application Priority Data
Jun. 18, 2009 (JP) 2009-145828
Aug. 13, 2009 (JP) 2009-187641

(51) Int. Cl. G06K 7/01

(52) U.S. Cl. 340/10.51

(57) ABSTRACT

A wireless IC tag to and from which data can be written and read between a writing/reading apparatus by way of wireless communication, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are connected to be mounted on a substrate so that communication in a frequency band longer than the UHF band is carried out by the antenna unit of the ferroelectric memory and data is saved in the ferroelectric memory, and at the same time communication in the UHF band is carried out by the UHF band communication antenna chip and the data is saved in the ferroelectric memory.

### TECHNICAL FIELD

The present invention relates to an RFID tag, a wireless IC tag called the RFID tag, and a management system using the IC tag and especially to a wireless IC tag which can accumulate a large amount of data and has a large communication area and a product management system using the wireless IC tag.

### BACKGROUND ART

In recent years, a non-volatile memory unit using an FeRAM which utilizes a ferroelectric as a memory device for an IC tag has been invented. The non-volatile memory unit includes a power source unit which receives a radio wave from outside and generates an electric current by resonance with the wave, an antenna unit for carrying out wireless communication, and a control unit for controlling these units (Patent Document 1).

The non-volatile memory unit described in the Patent Document 1 has advantages in various fields such as number of times for rewriting, lower writing voltage, unnecessity of a power source, longer life time of usage, and smaller cell size compared to an EEPROM conventionally used for an IC tag. At present, one IC tag has approximately 8 Kbyte of memory capacity and the tag itself functions as a memory unit while the tag also functions as a CPU, which is a computing device.

A passive-type wireless IC tag by the electromagnetic induction method, which is also called an RFID tag, causes a magnetic field, which is generated around a coil antenna by an LF band of 135 kHz and an HF band of 13.56 MHz applied to the antenna, to be a transmission medium to carryout communication with outside by an electromotive force induced by the antenna.

However, although it is possible to carry out stable communication by use of the above-mentioned LF band or HF band, communication range thereof is not wide and is not suitable for mobile communication. Especially, in a case where quality management is carried out by use of a wireless IC tag in a building built with concrete or a large facility such as a construction site, where it is desired to communicate in a wider communication range, there is a demand for carrying out communication in a frequency band suitable for an object of management or a system. Moreover, there is a demand for usage of a wireless IC tag having a large-volume memory from and to which large-volume data can be read and written.

Then, there is a demand for carrying out communication with two or more bandwidths having different characteristics such as an LF band and a UHF band by one wireless IC tag without carrying out a special processing to a non-volatile memory unit using an FeRAM.
Patent Document 1: Japanese Unexamined Patent Application Publication No. 2007-241576
Patent Document 2: Japanese Unexamined Patent Application Publication No. 2008-063900

### DISCLOSURE OF THE INVENTION

### Problem to be Solved by the Invention

Therefore, to solve the above-mentioned problems, the present invention aims at providing a wireless IC tag which can reduce the size of an antenna, has a wide communication range, has a communication function which corresponds to characteristic of a frequency bandwidth desired to be used from an LF band to a UHF band, and at the same time has a large-volume memory and aims at providing a product management system using the wireless IC tag.

### Means for Solving Problem

To solve the above-mentioned problems, the present invention is a wireless IC tag to and from which data can be written and read between a writing/reading apparatus by way of wireless communication, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are electrically connected to be mounted on a substrate so that communication in a frequency band longer than the UHF band is carried out by the antenna unit of the ferroelectric memory, data is saved in the ferroelectric memory, and at the same time communication in the UHF band is carried out by the UHF band communication antenna chip and the data is saved in the ferroelectric memory.

Moreover, the wireless IC tag of the present invention includes the ferroelectric memory using a ferroelectric having the power source unit for receiving a radio wave from outside and for generating an electric current by resonating with the radio wave and the antenna unit for carrying out wireless communication in a predetermined frequency bandwidth, and the UHF band communication antenna chip witch are mounted on the substrate via a control unit and covered with an insulating material.

Further, circumference of the wireless IC tag is covered with an alkali-fast thermoplastic resin material.

Further, the circumference of the wireless IC tag is covered with a thermoplastic resin material having a polyamide resin material strengthened by a glass fiber and a mineral filler.

Further, the wireless IC tag is formed to have an approximately same shape and approximately same weight as an aggregate mixed into a cement product.

Further, a concave portion is formed on a covering body which covers the wireless IC tag and cement is put into the concave portion to strengthen connection with the cement.

The wireless IC tag is electrically connected with a battery which is recharged by a recharging device in a contactless manner.

The battery is recharged in a contactless manner by a radio wave in a predetermined frequency band from the recharging device.

The battery is mounted on the substrate.

The recharging device for recharging the battery is provided to a writing/reading apparatus.

The wireless IC tag is electrically connected with a power generation mechanism for carrying out power generation by itself by vibration, heat, or radio wave.

The power generation mechanism is mounted on the substrate.

A wireless IC tag to and from which data can be written and read between a writing/reading apparatus by way of wireless communication, wherein the IC tag having a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate so that communication in a longer frequency band which exceeds the UHF band is carried out by the antenna unit of the ferroelectric memory and data is saved in the ferroelectric memory, and at the same time communication of data in the UHF band by the writing/reading apparatus is carried out by the UHF band communication antenna chip to save data in the ferroelectric memory is mounted on a management object by attaching, adhesion, embedding, carrying or the like and data is written in or read out to or from the wireless IC tag thus mounted by the writing/reading apparatus.

A wireless IC tag to and from which data can be written and read between the writing/reading apparatus by way of wireless communication, wherein the IC tag having a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate, and at the same time having a battery recharged in a contactless manner from a recharging device which is electrically connected so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out to or from the wireless IC tag thus mounted by the writing/reading apparatus.

A wireless IC tag to and from which data can be written and read between the writing/reading apparatus by way of wireless communication, wherein the IC tag having a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate, and at the same time having a power generation mechanism for carrying out self-power generation by vibration, heat, or radio wave which is electrically connected so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out to or from the wireless IC tag thus mounted by the writing/reading apparatus.

A wireless IC tag is mixed into a cement product in the production process of mixing cement, an aggregate, water, and the like, the wireless IC tag measures product characteristic values of the cement product by an automatic measurement device provided to the wireless IC tag in the measurement process of the cement product, and at the same time an IC tag writing device connected with the automatic measurement device writes product characteristic values measured by the automatic measurement device and product information such as production date, and after the cement product is built in a site to be a structural object, data is written in or read out into or from the wireless IC tag in the structural object by a writing/reading apparatus.

### Effect of the Invention

According to the above-mentioned configuration, it becomes possible to provide a hybrid-type wireless IC tag to and from which data can be written and read between a writing/reading apparatus by way of wireless communication, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip are electrically connected to be mounted on a substrate so that communication by the writing/reading apparatus in a frequency band longer than the UHF band is carried out by the antenna unit of the ferroelectric memory, data is saved in the ferroelectric memory, and at the same time communication by the writing/reading apparatus in the UHF band is carried out by the UHF band communication antenna chip and the data is saved in the ferroelectric memory to allow frequency bandwidth communication in a band exceeding the UHF band such as VHF band, HF band, MF band, or LF band and communication in the UHF band to be carried out only by electrically connecting the ferroelectric memory and a conventional UHF band communication antenna chip. Carrying out communication by use of the hybrid-type wireless IC tag, without setting the communication frequency of the wireless IC tag in each case, enables both, for example, communication in a long frequency band such as the LF band used when a stable communication is required and communication in the UHF band used when a wide range of communication is required and the data written in by the writing/reading apparatus to be saved in the large-capacity ferroelectric memory.

Further, since the ferroelectric memory using a ferroelectric having the power source unit for receiving a radio wave from outside and for generating an electric current by resonating with the radio wave and an antenna unit for carrying out wireless communication in a predetermined frequency bandwidth, and the UHF band communication antenna chip are mounted on the substrate via the control unit and covered with an insulating material, it becomes possible to provide a hybrid-type wireless IC tag which can switch communication between, for example, highly stable communication in the LF band and communication in the UHF band having a wide communication area, or use both of them thanks to the control by the control unit mounted on the ferroelectric memory. Carrying out communication by use of the hybrid-type wireless IC tag enables to save a large amount of data written in by the writing/reading apparatus in the ferroelectric memory having a large capacity.

Further, since the circumference of the wireless IC tag is covered with the alkali-fast thermoplastic resin, even if the wireless tag is thrown into a cement product such as fresh concrete, the wireless IC tag is not damaged by solution or the like by strong alkaline cement product and therefore it becomes possible to provide a wireless IC tag which is suitable for product management of a cement product, a concrete structural object, or the like.

Further, since the circumference of the wireless IC tag is covered with a thermoplastic resin material having a polyamide resin material strengthened by a glass fiber and a mineral filler, the wireless IC tag in a cement product is not damaged by pressure even when concrete is cast and therefore it becomes possible to provide a wireless IC tag suitable for product management of a cement product or a concrete structural object.

Further, since the wireless IC tag is formed to have the approximately same shape and approximately same weight as an aggregate mixed in a cement product, it becomes possible to disperse the wireless IC tags equally in the cement product when the wireless IC tags are thrown into the cement product.

Further, since a concave portion is formed on the covering body which covers the wireless IC tag and cement is put into the concave portion to strengthen connection with the cement, it becomes possible to increase affinity with a cement product in a case where the wireless IC tag is thrown into the cement product and therefore if a concrete structural object is cast, there is not a possibility of the concrete structural object to be broken from a portion where the wireless IC tag is embedded.

Since the wireless IC tag is electrically connected with a battery which is recharged by a recharging device in a contactless manner, even if the wireless IC tag is embedded in or provided to a concrete structural object where it is difficult to supply electricity to the wireless IC tag by a cable, it becomes possible to recharge from outside in a wireless manner. Therefore, it becomes possible to provide a wirelessly rechargeable wireless IC tag.

Since the battery is recharged in a contactless manner by a radio wave having a predetermined frequency band from the recharging device, it becomes possible to recharge by a radio wave from a wireless communication apparatus or other transmission apparatus and therefore there is not a possibility of heating or the like compared to recharging by use of, for example, electromagnetic induction and it becomes possible to safely carry out recharging in a contactless manner.

Since the battery is mounted on the substrate, it becomes possible to provide a small wireless IC tag which is modularized and can be recharged.

Since the recharging device for recharging the battery is provided to the data writing/reading apparatus, it becomes possible to recharge the wireless IC tag by use of an opportunity for writing or reading of data to or from the wireless IC tag.

Since the wireless IC tag is electrically connected with a power generation mechanism which generates power by itself by vibration, heat, or radio wave, even if the wireless IC tag is embedded in or provided to a concrete structural object or a bridge where it is difficult to supply electricity by a cable, it becomes possible for the wireless IC tag to generate power by itself using external energy such as vibration, heat, or radio wave and to accumulate power thus generated depending on the necessity. Therefore, it becomes possible to provide a wireless IC tag which can generate power by itself.

Since the power generation mechanism is mounted on the substrate, it becomes possible to provide a small modularized wireless IC tag which can generate power.

A wireless IC tag to and from which data can be written and read between a writing/reading apparatus by way of wireless communication, which includes a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out into or from the wireless IC tag thus mounted by the writing/reading apparatus. Thus, in a management system where communication distance from the writing/reading apparatus changes such as shipping management in a factory, management of books or documents stored in a cabinet, and traffic management of humans and vehicles, it becomes possible to carry out writing and reading of large volumes of data quickly and without fail and to provide a management system suitable for quick management and long-term management.

A wireless IC tag to and from which data can be written and read between a writing/reading apparatus by way of wireless communication, which includes a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate and a battery which is electrically connected with the tag and is recharged by a recharging device in a contactless manner so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like. Thus, in addition to the above-mentioned effect of writing or reading data into or from the wireless IC tag thus mounted by use of the writing/reading apparatus, the wireless IC tag can be recharged by radio wave from outside. Therefore, it becomes possible to utilize the present system which can supply necessary power even if the wireless IC tag is embedded in a concrete structural object where it is difficult to supply electricity to the wireless IC tag or an apparatus connected with the wireless IC tag by a cable.

A wireless IC tag to and from which data can be written and read between a writing/reading apparatus by way of wireless communication, which includes a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate and a power generation mechanism for carrying out self-power generation by vibration, heat, or radio wave is electrically connected with the tag so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like. Thus, in addition to the above-mentioned effect of writing or reading data into or from the wireless IC tag thus mounted by use of the writing/reading apparatus, the wireless IC tag can be recharged by self-power generation. Therefore, it becomes possible to utilize the present system which can generate necessary power even if the wireless IC tag is embedded in a concrete structural object where it is difficult to supply electricity from outside to the wireless IC tag or an apparatus connected with the wireless IC tag.

A wireless IC tag is mixed into a cement product in the production process of mixing cement, an aggregate, water, and the like, the wireless IC tag measures product characteristic values of the cement product by an automatic measurement device provided to the wireless IC tag in the measurement process of the cement product, and at the same time an IC tag writing device connected with the automatic measurement device writes product characteristic values measured by the automatic measurement device and product information such as production date, and after the cement product is built in a site to be a structural object, data is written in or read out into or from the wireless IC tag in the structural object by a writing/reading apparatus. Thus, it becomes possible to quickly and surely carry out writing and reading of large volumes of data with regard to data such as the source of the cement product, ratio of mixture, or data regarding the structural object after casting, to provide a concrete quality management system suitable for quick management and long-term management. As a result thereof, it becomes possible to contribute to safety or the like of a concrete structural object.

### BRIEF DESCRIPTION OF THE DRAWINGS

FIG. 1 A perspective view of a hybrid-type wireless IC tag of a first embodiment of the present invention.

FIG. 2 A cross-sectional view of the wireless IC tag of the first embodiment of the present invention.

FIG. 3 A plan view of a wireless IC tag of a fourth embodiment of the present invention wherein the wireless IC tag of the first embodiment is covered with a covering body.

FIG. 4 A cross-sectional view in a longitudinal direction of the wireless IC tag shown in FIG. 3.

FIG. 5 A cross-sectional view in a lateral direction of the wireless IC tag shown in FIG. 4.

FIG. 6 A schematic view showing an example of a management system using the wireless IC tag of the present invention.

FIG. 7 A schematic view showing an example of a concrete quality management system using the wireless IC tag of the present invention.

FIG. 8 A perspective view of a hybrid-type wireless IC tag of a second embodiment of the present invention.

FIG. 9 A schematic view showing an example of a recharging system using the wireless IC tag shown in FIG. 8.

FIG. 10 A perspective view of a hybrid-type wireless IC tag of a third embodiment of the present invention.

### DESCRIPTION OF REFERENCE NUMERALS

1: Wireless IC tag;
2: Substrate;
21: Wire;
3: FeRAM chip;
4: UHF band communication antenna chip;
5: Covering body;
6: Reader/writer;
7: Computer;
8: Wireless IC tag;
9: Covering body;
91: Concave portion;
10: Computer;
11: IC tag writing device;
12: Central control server;
13: Concrete mixer vehicle;
14: Reader/writer;
15: Wireless IC tag;
16: Battery;
17: Wireless IC tag; and
18: Power generation mechanism

### BEST MODE FOR CARRYING OUT THE INVENTION

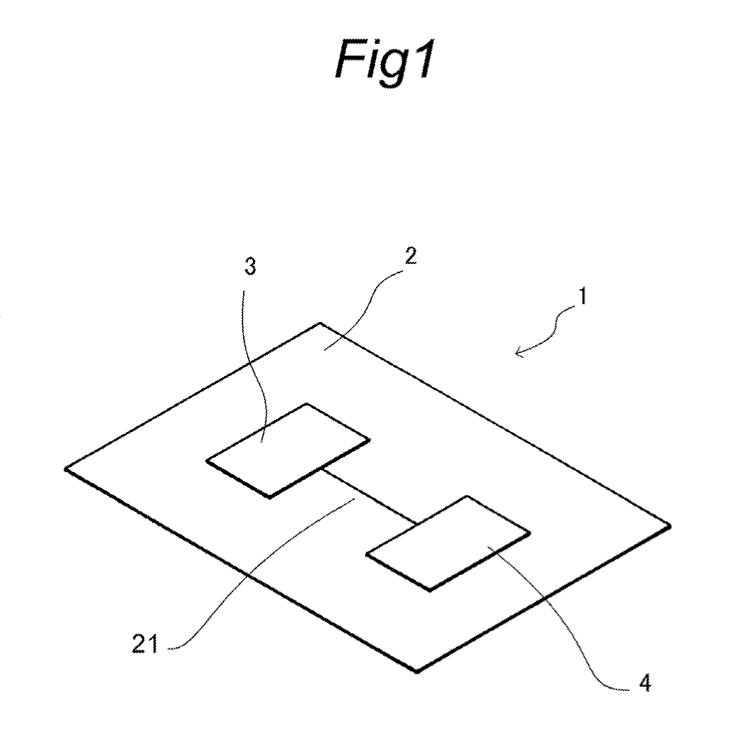

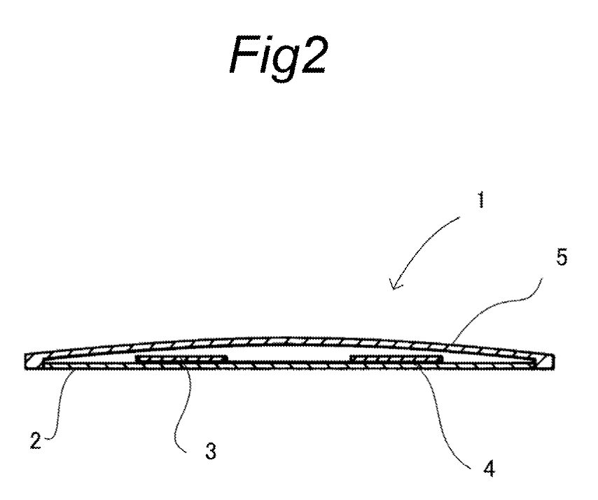

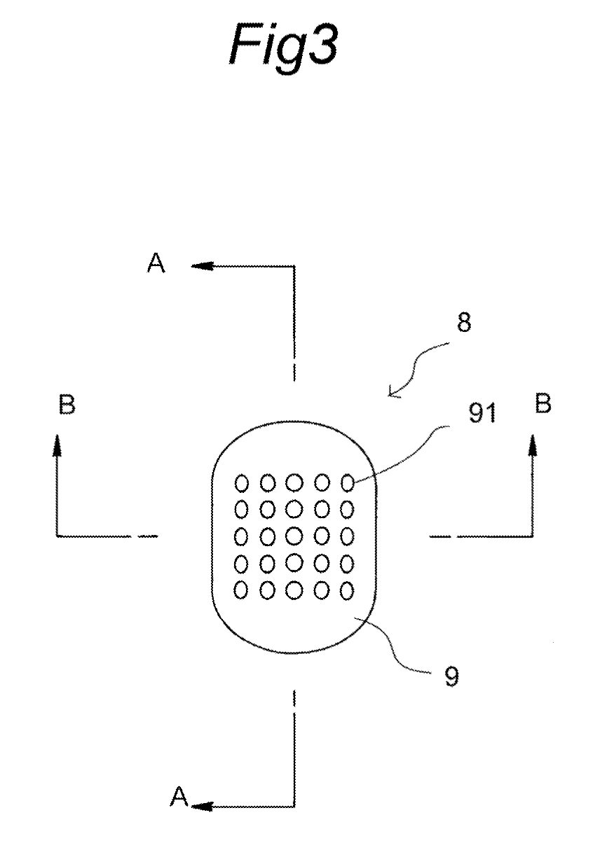

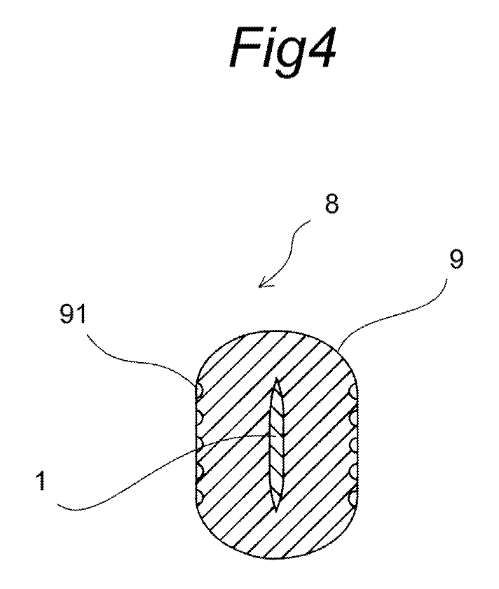

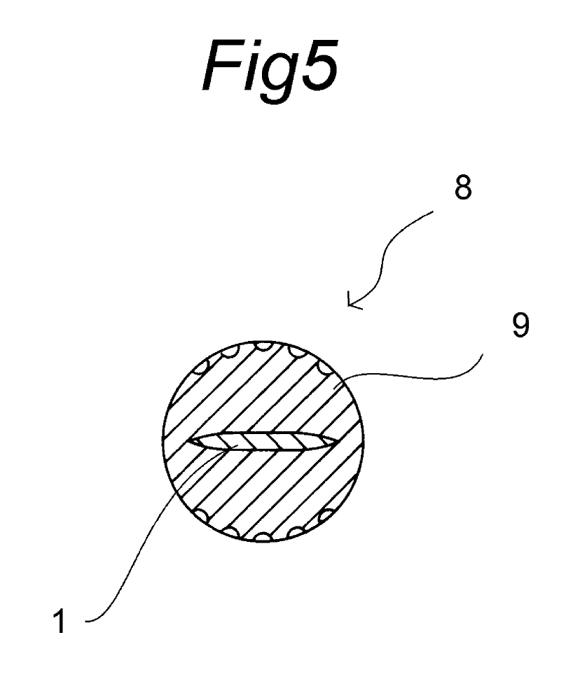

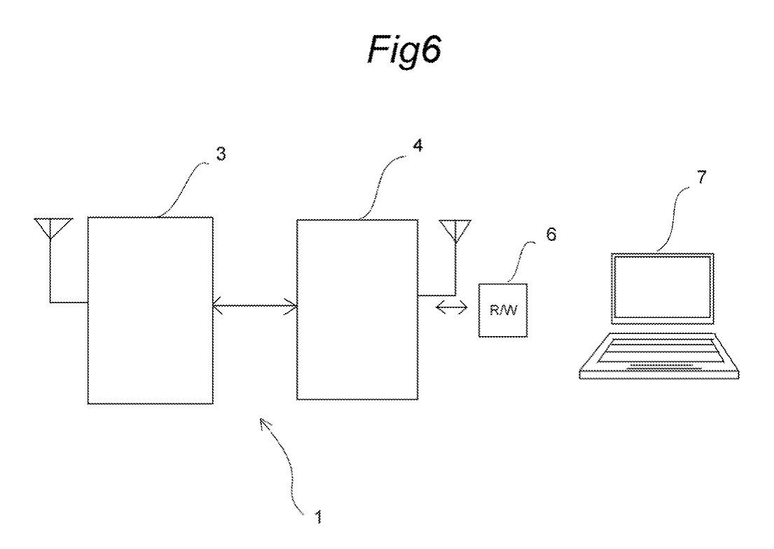

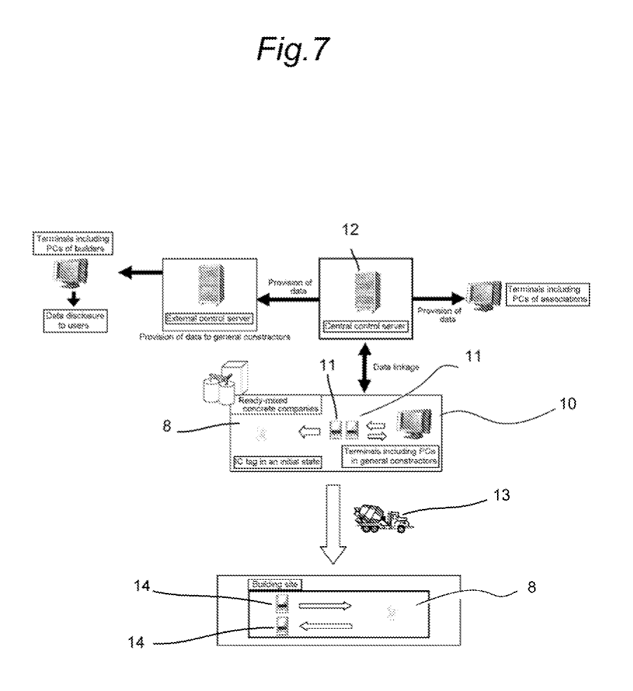

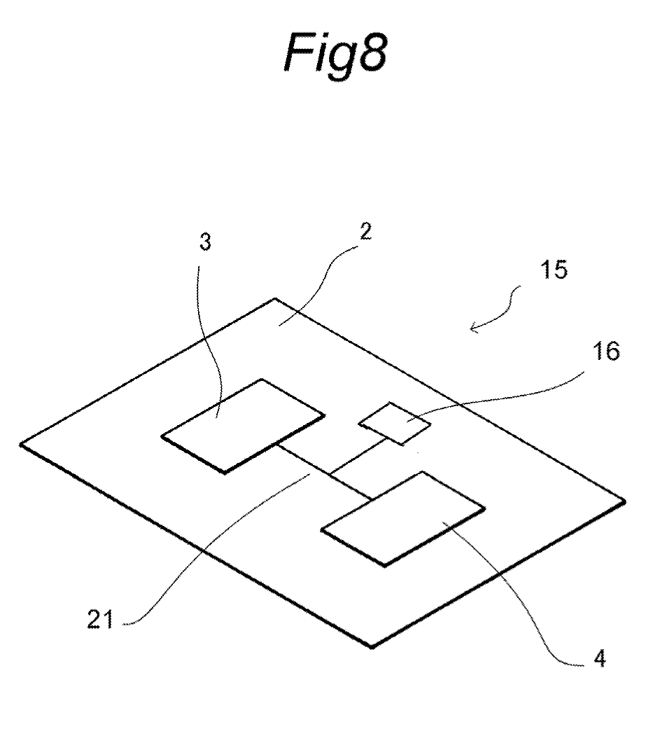

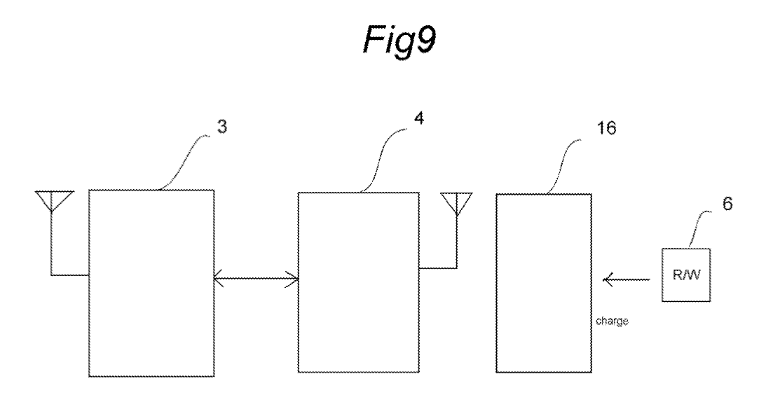

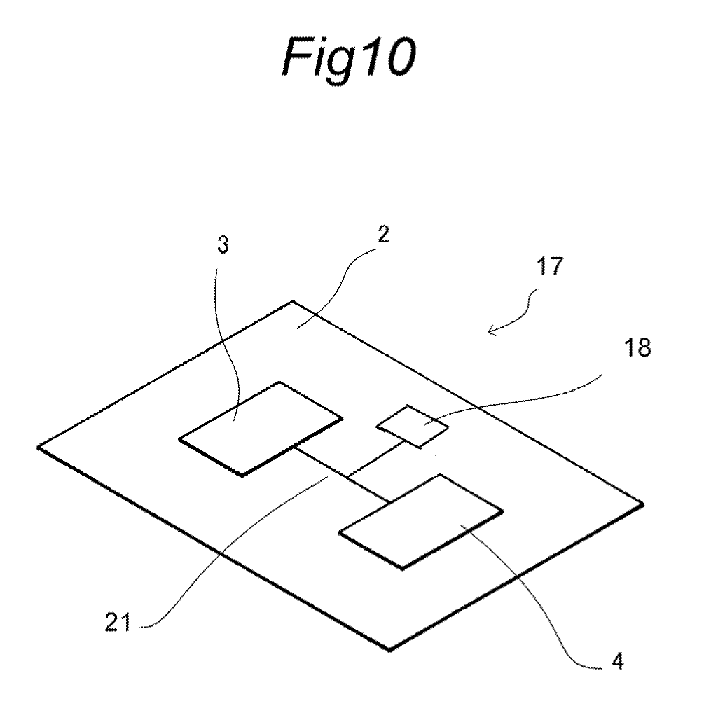

FIG. 1 is a perspective view of a hybrid-type wireless IC tag of the present invention, FIG. 2 is a cross-sectional view of the wireless IC tag of the present invention, FIG. 3 to FIG. 5 are a plan view, a cross-sectional view in a longitudinal direction, and a cross-sectional view in a lateral direction of a wireless IC tag in a status where the wireless IC tag of the present invention is covered with a covering body, FIGS. 6 and 7 are schematic views showing an example of a management system using the wireless IC tag of the present invention, FIG. 8 is a perspective view of a second embodiment of a hybrid-type wireless IC tag of the present invention, FIG. 9 is a perspective view showing an example of recharging the wireless IC tag shown in FIG. 8, and FIG. 10 is a perspective view of a third embodiment of a hybrid-type wireless IC tag of the present invention.

A wireless IC tag 1 of the present invention showing a configuration view of an embodiment of the present invention is a hybrid-type wireless IC tag which is a memory unit also called an RFID tag to and from which data can be written and read and includes an FeRAM called a ferroelectric memory utilizing a ferroelectric as a memory device for the IC tag and a UHF band communication antenna chip 4 for receiving radio waves in a UHF bandwidth. The FeRAM and the UHF band communication antenna chip 4 are electrically connected and mounted on one substrate 2.

An FeRAM chip 3 mounting an FeRAM utilizing a ferroelectric as a memory device for an IC tag and the UHF band communication antenna chip 4 for receiving radio waves in the UHF bandwidth are mounted on the wireless IC tag 1 and circuits of the FeRAM chip 3 and the UHF band communication antenna chip 4 are configured by a wire 21 so that data can be mutually exchanged.

Type of the FeRAM which configures the FeRAM chip 3 may be any type such as a capacitor type or a transistor type. Here, one which is easy for use in a management system of a product or the like is a passive type FeRAM which does not include a power source but rectifies a radio wave for data access from outside to use the wave as a power source. The FeRAM chip 3 has an FeRAM which is a non-volatile memory utilizing a ferroelectric, a power source unit which generates an electric current by receiving and resonating with a radio wave from outside instead of incorporating a battery for driving, a film antenna unit for carrying out wireless communication, and a control unit for controlling the FeRAM chip 3 and the UHF band communication antenna chip 4.

When compared with an EEPROM which has been used for a conventional wireless IC tag, the FeRAM has a function superior to the EEPROM in that times of rewriting of the EEPROM is approximately fifth power of 10 while the FeRAM can rewrite 13 power of 10 times or more. Moreover, writing voltage of the conventional EEPROM is 12V while the FeRAM is between DC 1.1 and 3V, which is quite low voltage. Therefore, a battery does not need to be incorporated in the wireless IC tag and a passive type having a power source unit for generating power by resonating with a radio wave from outside is sufficient for use and compared with the EEPROM which has been used for a conventional IC tag, writing speed of the FeRAM is 5000 times faster. Further, data retention period is 10 years or more, which is relatively longer. Further, there is another advantage in an access for rewriting. While writing was carried out by the unit of a block for the conventional EEPROM or a flash memory, FeRAM can carry out writing randomly by the unit of a word.

The control unit can be also set to prevent overwriting while information can be added to prevent information which was written in before from being falsified and it is preferable that writing/reading of data is carried out by use of a protocol. Therefore, it becomes possible to carry out writing/reading of each data by way of wireless communication with a reader/writer 6 as a writing/reading apparatus within approximately 8 KB of memory capacity.

A bandwidth of a radio wave in which the FeRAM chip 3 can carry out wireless communication can be set freely and any band from LF band to UHF band suitable for small wireless communication can be used. However, it is suitable to set the band width of the antenna unit to communication in the LF band which enables stable communication by ground wave, has weak directionality, is relatively less subject to effect by water, dust, and a metal, and can carry out highly reliable data communication. Here, bandwidth of the antenna unit may be set to be one for frequency band communication such as VHF band, HF band, or MF band.

On the other hand, for a case where management of a moving object or management in a wide area is carried out, the UHF band communication antenna chip 4 set for communication in the UHF band having a wide communication area such as several meters of communication distance for reading and writing of data by way of the reader/writer 6 is mounted. One having a function of only a UHF band communication antenna is sufficient as the UHF band communication antenna chip 4. However, it becomes possible to provide the hybrid-type wireless IC tag 1 at low cost if a conventional UHF memory chip having a small memory capacity is mounted on the substrate and the UHF memory chip is used as the UHF band communication antenna.

Control of the FeRAM chip 3 and the UHF band communication antenna chip 4 is carried out by the control unit mounted on the FeRAM chip 3. Communication is carried out by the antenna unit of the FeRAM chip 3 or the UHF band communication antenna chip 4 depending on the communication frequency band of the reader/writer 6 as a reading/writing apparatus, and at the same time, transmitted data is controlled by the control unit and saved in the large-volume memory of the FeRAM chip 3.

If, for example, a radio wave of an LF band frequency is output from the reader/writer 6, the antenna unit of the FeRAM chip 3 receives the radio wave and the control unit controls so that the data thus transmitted is saved in the memory unit of the FeRAM chip 3. Meanwhile, if a radio wave of a UHF band frequency is output from the reader/writer 6, the UHF band communication antenna chip 4 receives the radio wave and on receiving the radio wave by the UHF band communication antenna 4, it is controlled so that the data thus transmitted is saved in the memory unit of the FeRAM chip 3 and the data is saved in the memory unit of the FeRAM chip 3 via the UHF band communication antenna chip 4. Here, the control unit may be provided separately from the FeRAM chip 3 and circuits of the FeRAM chip 3 and the UHF band communication antenna chip 4 may be configured via the control unit.

Here, a management flag which can be read by the reader/writer 6 is saved in advance or when writing in the FeRAM chip 3 of the wireless IC tag 1 and the management flag is read by the reader/writer 6 when information is read or written so that it can be identified that the wireless IC tag 1 is one configuring a predetermined management system. Here, depending on the necessity, anti-collision function can be mounted on the wireless IC tag 1 so that communication is not disabled due to interference in a case where a plurality of wireless IC tags 1 are positioned in the vicinity of each tag.

As shown in FIG. 2, the substrate 2 on which each of the chips is mounted is covered with an insulating body 5 including an insulating material so that the wireless IC tag 1 is not damaged when attached to, embedded into, or carried with the management target. A plastic resin or the like is suitable for the insulating material of the insulating body 5 and the insulating body 5 may cover the upper side of the substrate 2 or may be resin molded so as to coat the whole of the substrate 2.

Next, as a second embodiment of the present invention, a condition of a wireless IC tag 15 where a battery which is recharged from a recharging device in a contactless manner is being electrically connected will be explained. As shown in FIG. 8, the wireless IC tag 15 is the wireless IC tag 1 of the first embodiment to which a battery which can be recharged by wireless communication is provided and includes a recharging mechanism. Then, for example, the tag is recharged by communication from the reader/writer 6 which mounts or also functions as a recharging device, as shown in FIG. 9. The other configuration of the wireless IC tag 15 is same as that of the wireless IC tag 1 of the first embodiment.

The FeRAM chip 3 mounting an FeRAM utilizing a ferroelectric as a memory device for an IC tag, the UHF band communication antenna chip 4 for receiving radio wave in the UHF bandwidth, and a battery 16 which can be recharged by wireless communication are mounted on the wireless IC tag 15. The battery 16 which is a secondary battery having a wireless communication mechanism for receiving a radio wave in a specific frequency bandwidth is provided on the substrate 2 and is electrically connected with the FeRAM chip 3 and, depending on the necessity, with various devices. As shown in FIG. 9, communication is carried out between the wireless communication mechanism of the recharging device provided to the reader/writer 6 and the battery provided to the wireless IC tag side by use of near field communication technology to recharge the secondary battery on the wireless IC tag side. The electric power thus accumulated is used as a power source for driving the wireless IC tag 15 or an apparatus connected to the wireless IC tag 15.

For example, when the wireless IC tag 15 embedded in a concrete structural object or the like and the reader/writer 6 having a recharging device carry out wireless communication, the battery 16 is recharged.

Here, a method of recharging may be one using electromagnetic induction in addition to the above-mentioned near field communication technology. That is, a coil is provided respectively to the recharging device and the battery and if an electric current is caused to flow to the coil on the recharging device side, an electric current flows to the coil on the battery side and this electric current is accumulated. Moreover, the recharging device may not be mounted on the reader/writer 6 and may be separately provided. In addition, the battery 16 may not be provided on the substrate 2 and may be electrically connected with the wireless IC tag.

Next, as a third embodiment of the present invention, a wireless IC tag 17 in a condition where a power generation mechanism is being electrically connected will be explained. As shown in FIG. 10, the wireless IC tag 17 is a wireless IC tag including a power generation mechanism. This is the wireless IC tag 1 of the first embodiment to which a power generation mechanism which generates power by itself is provided. Other configuration is same as that of the wireless IC tag 1 of the first embodiment.

The FeRAM chip 3 mounting an FeRAM utilizing a ferroelectric as a memory device for an IC tag, the UHF band communication antenna chip 4 for receiving a radio wave in the UHF bandwidth, and a power generation mechanism 18 are mounted on the wireless IC tag. The power generation mechanism 18 is mounted on the substrate and is electrically connected with the FeRAM chip 3 and, depending on the necessity, with various devices. The power generation mechanism 18 is a vibration power generation device which generates power by vibration and generates relatively weak power by motion of a human, vibration caused by driving of the device, and vibration of a building and a bridge caused by passage of a vehicle or the like. Then, the power generated by the power generation mechanism may be directly used or may be accumulated in a secondary battery provided to the power generation mechanism. The power generation mechanism 18 is used as a power source for driving the wireless IC tag or a device connected to the wireless IC tag.

For example, in a case where a human carrying the wireless IC tag 17 moves or the wireless IC tag 17 embedded in or attached to a concrete structural object, a bridge, a product, or the like is vibrated by passage of a vehicle or the like or by swing while being carried, the power generation mechanism 18 generates power utilizing the vibration as energy.

Here, the power generation mechanism 18 is not limited to the above-mentioned vibration power generation device and may be a mechanism which generates power by heat from outside as a thermoelectric device and may be a power generation mechanism by wireless communication which generates power by radio wave from outside such as RF wave, and may be a mechanism which uses various types of external energy, which is generally called harvester technology. Here, the power generation mechanism 18 may not be provided on the substrate 2 and may be electrically connected with the wireless IC tag 17.

Hereinafter, as a fourth embodiment of a wireless IC tag, a wireless IC tag 8 having the wireless IC tag 1 which is covered with a covering body 9 so that the wireless IC tag can be used for a concrete quality management system for managing a later-described cement product or a concrete structural object will be explained. The management targets of the management system by the wireless IC tag 8 are, especially, a cement product and a concrete structural object. Therefore, the wireless tag 8 is for a system aimed at carrying out management of a cement product or a concrete structural object after casting in which the tag is thrown into a cement product in the manufacturing process of the cement product in a cement factory, where water, an aggregate, and cement are mixed. Therefore, it is required for the wireless IC tag to have an affinity with the cement, to have dispersiveness after being thrown into the mixture, and to have strength and shape suitable for reading and writing of data when thrown into the mixture and after casting.

The wireless IC tag 8 has the wireless IC tag 1 which is covered with the covering body 9. On the surface of the covering body 9, a concave portion 91 is processed. A plurality of minute concave portions are dimpled on the surface of the covering body 9 to form the concave portion 91 and cement product fills the concave portion to obtain adhesiveness and affinity between the wireless IC tag 1 and the cement product. Moreover, forming the concave portion 91 improves strength of the wireless IC tag 1. In the present embodiment, a total of 50 points, 25 each on both surfaces of the wireless IC tag, are dimpled, so that dimple processing is carried out when mold injection is carried out. However, dimple processing may be carried out on all the surfaces or only partially. Further, depth of the concave portion in the present embodiment is approximately between 0.2 and 0.5 mm. However, the depth is not limited thereto. The concave portion 91 is not limited to dimple processing and a concave hole may be formed on the surface of the covering body 9, the covering body 9 may be curved, or the covering body 9 may be shaped to have a concave lens shape to provide a concave portion.

Here, it is preferable that specific weight of the wireless IC tag 1 is within a range of between 1.3 and 1.9, which is in the vicinity of specific weight of the aggregate and the tag is set to have the specific weight of 1.5 in the present embodiment. According to a dispersion experiment of the wireless IC tag 8 in the concrete, if the tag is formed to have the specific weight of 1.3 or less, the wireless IC tag 8 floats in the cement product and therefore there is a possibility that the tag is exposed on the surface of the cement product. If the tag is formed to have the specific weight of 1.9 or more, the wireless tags 1 do not disperse in the cement product but sink or are located eccentrically. It is confirmed that the wireless IC tag 1 formed to have the specific weight of approximately 1.5 is most equally dispersed in the vicinity of the surface of the cement product. That is, when a plurality of wireless IC tags 1 having a specific weight of 1.5 were thrown into the 1 m³ of cement product in the process of the cement product manufacturing in which an aggregate, cement, water, and the like are mixed, the wireless IC tags were located in positions with an average depth of 9.3 cm from the surface of the cement product and a standard deviation of 3.826, median of 8.00, minimum value of 4.17, and maximum value of 11.83 were obtained. Therefore, even with the wireless IC tag 1 having a writing/reading distance of approximately 10 cm by wireless communication, it is possible to carry out writing/reading of information without fail.

It is preferable that size of the wireless IC tag 8 is set to be similar to the size of the aggregate. In the present embodiment, the tag is formed to be an approximately oval sphere with the length of 17 mm in the longitudinal direction and 12 mm in the lateral direction, and to have higher affinity with the cement product so that the tag does not sink in the cement product.

The covering body 9 is formed with thermoplastic resin material and covers the tag so as to position the wireless IC tag 1 at the center of the covering body 9. Specifically, the covering body 9 uses alkaline-fast resin material which can resist strong alkaline of PH 12.0 to 13.0 and can resist temperature of approximately 100° C. which is applied when the aggregate, water, and cement are mixed. In the embodiment of the present invention, a polyamide resin is used and especially, in a case where a polyamide MXD6 composite resin is used as a material of the covering body 9, superior mechanical strength and coefficient of elasticity were obtained in a wide range of temperature. Moreover, it was confirmed that this covering body using the polyamide MXD6 composite resin has a low water absorption coefficient and change in dimension or deterioration in mechanical strength by water absorption when mixed with the aggregate, water, cement, and the like is low.

Here, Reny material (manufactured by Mitsubishi Engineering-Plastics Corporation) which includes the polyamide MXD6 composite resin reinforced with non-permeable glass fiber, a mineral filler, or the like is used as the covering body 9. A wireless IC tag main body is covered with the covering body 9 and is injection molded. It is confirmed that the wireless IC tag 8 in this case can resist an average of 197 kgf of load from the longitudinal direction and at least an average of 148 kgf of load from the lateral direction. Moreover, according to an expansion test of a tag by way of enhancement of alkaline aggregate reaction, when the wireless IC tags 1 were thrown into a cement product in its manufacturing process of mixing the aggregate, water, cement, and the like, an average expansion ratio was 0.49%, which does not influence the cement product after the cement product is dried up. In addition, although the covering body includes a non-permeable glass fiber, the covering body does not include a substance having magnetic property such as ferrite and therefore the covering body does not influence wireless communication. Here, the thermoplastic resin material used for the covering body 9 may be any of a urethane resin, a vinyl chloride resin, a styrene group resin, an olefin group resin, or a polyester group resin, other than the polyamide resin.

Here, the wireless IC tag covered with the covering body 9 may be either the wireless IC tag 15 having the battery 16 which can be recharged by way of wireless communication from outside or the wireless IC tag 17 having the power generation mechanism 18, other than the above-mentioned wireless IC tag 1.

Hereinafter, a management system using the wireless IC tag 1 will be explained with reference to some examples. In the management system using the wireless IC tag 1, the FeRAM chip 3 and the UHF band communication antenna chip 4 configuring the wireless IC tag 1 are mounted on the substrate 2 as shown in FIG. 1 and the FeRAM chip 3 and the UHF band communication antenna chip 4 are system structured to be enabled to mutually exchange data as shown in FIG. 6. Then, the antenna units of the chips are enabled to communicate with the reader/writer 6 in the LF or UHF frequency bandwidth.

The reader/writer 6 can carry out data communication with the wireless IC tag 1 by switching to either or both of LF or UHF frequency bandwidth and can read and write data regarding a target of management by wireless communication with the wireless IC tag 1.

If write data is output from the reader/writer 6, the antenna unit of either the FeRAM chip 3 or the UHF band communication antenna chip 4 of the wireless IC tag 1 which corresponds to the frequency band output from the reader/writer 6 receives the data and the data is saved in the memory of the FeRAM chip 3. Moreover, if a read signal is output from the reader/writer 6, the antenna unit of either the FeRAM chip 3 or the UHF band communication antenna chip 4 of the wireless IC tag 1 which corresponds to the frequency band output from the reader/writer 6 receives the signal and data saved in the FeRAM chip 3 is output to the reader/writer 6 from the antenna unit. Then the data thus read out by the reader/writer 6 may be stored in a computer 7.

As an embodiment example of a management system using the wireless IC tag having such a configuration, a concrete quality management system will be explained based on FIG. 7. First, a plurality of the wireless IC tags 8 in initial state which include the wireless IC tags 1 covered with the covering body 9 are prepared and are mixed into a cement product in a cement product manufacturing process of mixing cement, aggregate such as gravel, water, and the like with the ratio of approximately one wireless IC tag per 1 m³ of the cement product in a concrete company. At this time, an automatic measurement device provided to a measurement process of the cement product measures product characteristic values such as ratio of water and cement of the cement product, cement admixture, or temperature, and at the same time an IC tag writing device 11 connected with the automatic measurement device automatically writes the product characteristic values thus measured by the automatic measurement device and production information such as production date. Moreover, the production information thus written in the wireless IC tag 1 is also recorded in a central control server 12 for central control of the concrete quality management system so that data are linked in organizations concerned such as a computer 10 of the concrete company.

In addition, the cement product in which the wireless IC tags 8 are mixed is loaded on a concrete mixer vehicle 13. Transportation information such as date of transportation is written in the wireless IC tags 8 mixed in the cement product in the concrete mixer vehicle 13 by the reader/writer which is incorporated into a personal digital assistant (PDA) and previously set to carry out wireless communication with a previously encrypted signal by a person in charge of transportation or the like.

Further, when the concrete mixer vehicle 13 arrives the site, a person in charge at the site uses a reader/writer 14 which is also incorporated into a PDA to write reception information such as receiving date and time, test results, and confirmation of mixture by use of an encrypted signal into the wireless IC tag 1 and at the same time records the information in the central control server 12. Then, the concrete product in which the wireless IC tags 1 are mixed is cast and a concrete structural object is formed. A general contractor in charge of construction at the site can also record structural object information as needed such as reinforcement arrangement data by use of the reader/writer 14 into the wireless IC tag 8 at a position in the object by the unit of construction zone or construction part of the concrete structural object.

After the concrete structural object is thus complete, it is possible to read various information recorded in the wireless IC tag 8 in the concrete structural object by use of the reader/writer 14 incorporated in the PDA which is set to carry out wireless communication by the previously set encrypted signal.

Moreover, the above-mentioned central control server 12 controls information written in the wireless IC tags 1 in a plurality of sites and provides the information to a contractor on the site, a client of construction, a user, various industry organizations, or the like depending on the necessity.

An example of another management system using the wireless IC tag will be explained. A shipping management system using the wireless IC tag 1 can be used for management of transportation destination by a transportation company or logistics management system for traceability of a product by attaching the wireless IC tag 1 to the product and writing product information, manufacturing information, transportation destination information or the like to the tag by use of the reader/writer 6 when the product is shipped from a factory or manufactured. On a line of a factory, information is written via the UHF band communication antenna chip 4 which has a wide communication area and is suitable for mobile communication and after shipment, information can be read or written via the antenna unit of the FeRAM chip 3 by a handheld reader/writer used in the LF band frequency bandwidth.

Moreover, a book or document management system using the wireless IC tag 1 can be used in a book storeroom or a cabinet for management of lending of a book by a library or entering and dispatching management system of documents in a company by attaching the wireless IC tag 1 to a book or a document and writing classification information of the book or the document, entering and dispatching information, ID of a borrower, or the like by the reader/writer 6. In a book storeroom or the like, storage position of a book or a document is sought from the classification information via the UHF band communication antenna chip 4 which has a wide communication area and when lending or selling, information can be read or written via the antenna unit of the FeRAM chip 3 by a handheld reader/writer used in the LF band frequency bandwidth.

Further, a management system of traffic volume or the like using the wireless IC tag 1 can be used for a management system for research of traffic volume or record of passage or for providing present location information by causing a person or a vehicle to carry the wireless IC tag 1 and the reader/writer 6 writes in or reads out identification information when the person or the vehicle passes through an observation point where the reader/writer 6 is set. For data communication in a wide area or at a gate of a highway or the like, where high-speed data communication is required, communication is carried out via the UHF band communication antenna chip 4 and in the case of a train ticket gate where secure data communication is required, information is read out or written in via the antenna unit of the FeRAM chip 3.

Here, the example of the management system is not limited to the above-mentioned ones and the wireless IC tag can be used for various management systems by being attached to, embedded in, or carried with a target object.

Here, the wireless IC tag used for the management system may be either the wireless IC tag 15 having the battery 16 which can be recharged by way of wireless communication from outside or the wireless IC tag 17 having the power generation mechanism 18, other than the above-mentioned wireless IC tag 1.

### INDUSTRIAL APPLICABILITY

It becomes possible to provide a hybrid-type wireless IC tag which can carry out communication in a frequency bandwidth exceeding the UHF band such as the VHT band, HF band, MF band, and the LF band and communication in the UHF band by electrically connecting a ferroelectric memory and a heretofore known UHF band communication antenna chip. If communication is carried out by use of this hybrid-type wireless IC tag, it becomes possible to carry out both, for example, the long frequency band communication such as LF band used when stable communication is required and the UHF band communication used when wide communication area is required, without setting the communication frequency of the wireless IC tag in each case. At the same time, the data thus written in by the writing/reading apparatus can be saved in a large-volume ferroelectric memory.

1. A wireless IC tag to and from which data can be written and read between a writing/reading apparatus by way of wireless communication, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are electrically connected to be mounted on a substrate so that communication in a frequency band longer than the UHF band is carried out by the antenna unit of the ferroelectric memory and data is saved in the ferroelectric memory, and at the same time communication in the UHF band is carried out by the UHF band communication antenna chip and the data is saved in the ferroelectric memory.

2. The wireless IC tag according to claim 1, wherein the ferroelectric memory using a ferroelectric having the power source unit for receiving a radio wave from outside and for generating an electric current by resonating with the radio wave and the antenna unit for carrying out wireless communication in a predetermined frequency bandwidth, and the UHF band communication antenna chip are mounted on the substrate via a control unit and they are covered with an insulating material.

3. The wireless IC tag according to claim 1, wherein the circumference of the wireless IC tag is covered with an alkali-fast thermoplastic resin material.

4. The wireless IC tag according to claim 3, wherein the circumference of the wireless IC tag is covered with a thermoplastic resin material having a polyamide resin material strengthened by a glass fiber and a mineral filler.

5. The wireless IC tag according to claim 3, wherein the wireless IC tag is formed to have an approximately same shape and approximately same weight as an aggregate mixed into a cement product.

6. The wireless IC tag according to claim 3, wherein a concave portion is formed on a covering body which covers the wireless IC tag and cement is put into the concave portion to strengthen connection with the cement.

7. The wireless IC tag according to claim 1, wherein the wireless IC tag is electrically connected with a battery which is recharged by a recharging device in a contactless manner.

8. The wireless IC tag according to claim 7, wherein the battery is recharged in a contactless manner by a radio wave in a predetermined frequency band from the recharging device.

9. The wireless IC tag according to claim 7, wherein the battery is mounted on the substrate.

10. The wireless IC tag according to claim 7, wherein the recharging device for recharging the battery is provided to a writing/reading apparatus.

11. The wireless IC tag according to claim 1, wherein the wireless IC tag is electrically connected with a power generation mechanism for carrying out power generation by itself by vibration, heat, or radio wave.

12. The wireless IC tag according to claim 10, wherein the power generation mechanism is mounted on the substrate.

13. A management system using a wireless IC tag, wherein the wireless IC tag to and from which data can be written and read between a writing/reading apparatus by way of wireless communication and which has a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out to or from the wireless IC tag thus mounted by the writing/reading apparatus.

14. The management system using a wireless IC tag according to claim 13, wherein the wireless IC tag to and from which data can be written and read between the writing/reading apparatus by way of wireless communication and which has a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip which are electrically connected to be mounted on a substrate, and at the same time has a battery recharged in a contactless manner from a recharging device which is electrically connected so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out to or from the wireless IC tag thus mounted by the writing/reading apparatus.

15. The management system using a wireless IC tag according to claim 13, wherein the wireless IC tag to and from which data can be written and read between the writing/reading apparatus by way of wireless communication and which has a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip mounted on a substrate, and at the same time has a power generation mechanism for carrying out self-power generation by vibration, heat, or radio wave which is electrically connected so that communication in a longer frequency band which exceeds the UHF band is carried out by the antenna unit of the ferroelectric memory and data is saved in the ferroelectric memory and at the same time communication of data in the UHF band by the writing/reading apparatus is carried out by the UHF band communication antenna chip to save data in the ferroelectric memory, is mounted on a management object by attaching, adhesion, embedding, carrying or the like and data is written in or read out to or from the wireless IC tag thus mounted by the writing/reading apparatus.

16. The management system using a wireless IC tag according to claim 13, wherein a wireless IC tag is mixed into a cement product in the production process of mixing cement, an aggregate, water, and the like, the wireless IC tag measures product characteristic values of the cement product by an automatic measurement device provided to the wireless IC tag in the measurement process of the cement product, and at the same time an IC tag writing device connected with the automatic measurement device writes product characteristic values measured by the automatic measurement device and product information such as production date, and after the cement product is cast in a site to be a structural object, data is written in or read out into or from the wireless IC tag in the structural object by a writing/reading apparatus.

17. The wireless IC tag according to claim 2, wherein the circumference of the wireless IC tag is covered with an alkali-fast thermoplastic resin material.

18. The wireless IC tag according to claim 4, wherein the wireless IC tag is formed to have an approximately same shape and approximately same weight as an aggregate mixed into a cement product.

19. The wireless IC tag according to claim 4, wherein a concave portion is formed on a covering body which covers the wireless IC tag and cement is put into the concave portion to strengthen connection with the cement.

20. The wireless IC tag according to claim 5, wherein a concave portion is formed on a covering body which covers the wireless IC tag and cement is put into the concave portion to strengthen connection with the cement.
